(19) United States
(12) Patent Application Publication
(10) Pub. No.: US 2005/0056167 A1
(43) Pub. Date: Mar. 17, 2005

(54) Aluminum can crushing kit

(76) Inventor: Lyle J. Christiansen, Morris, MN (US)

Correspondence Address: Lyle J. Christiansen, 701 Imperial Drive, Morris, MN, 56267, US

(21) Appl. No.: 10/662,244

(22) Filed: Sep. 16, 2003

(51) Int. Cl. B30B 5/00

(52) U.S. Cl. 100/902; 100/245

(57) ABSTRACT

A unique lightweight aluminum can crusher kit when packaged for shipping but which becomes a heavyweight, crush-them-flatter crusher for the operator when gravel is poured into the body of the crusher and the two-handed-operated crusher is forcibly dropped on a can.

### CROSS-REFERENCE TO RELATED APPLICATIONS

Not applicable.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC.

Not applicable.

### BACKGROUND OF THE INVENTION

Field of the invention: This invention applies to aluminum can crushers that utilize the weight of the unit to drop on an aluminum can to crush it flat and is hand operated.

There are many wall mounted can crushers with a handle and piston to crush a can and they are hand operated. They don't supply the necessary power to completely flatten the cans. Applicant's can crusher flattens the cans much more.

U.S. Pat. No. 4,682,539 by Bramblett shows a can crusher which includes a relatively heavy tramping element which would be a big drawback if it was to be manufactured and distributed. It also is operated by just one hand which would lessen the control an operator would have while using the crusher and also would lesson the strength of the blow to the cans which are to be crushed.

Applicant's can crusher's shipping weight would be light. The kit would contain the unit's body and slipped into the body would be the two handles, spacers, two bolts with nuts and washers, and that's all. The buyer would assemble the kit and add weight into the body such as gravel. The heavy weight of the can crusher dropping on a can crushes the can flat. The two handles gives an operator excellent control and also able to give a blow with added muscular force when helping speed the crusher on its downward movement. A tough striking plate on the crusher's bottom cover serves to protect the cover as the cans are crushed.

### BRIEF SUMMARY OF THE INVENTION

Applicant's can crusher kit supplies a user with a powerful way to crush aluminum cans and to crush them flatter than a wall mounted handle and piston crusher. The unique construction allows a heavy material, such as gravel, to be poured into the body of the crusher. This feature allows a manufacturer to produce a lightweight product for shipping and marketing because the gravel can be added to the crusher by a buyer after it arrives.

### BRIEF DESCRIPTION OF THE DRAWING

FIG. 1 shows a front and somewhat above view of the can crusher.

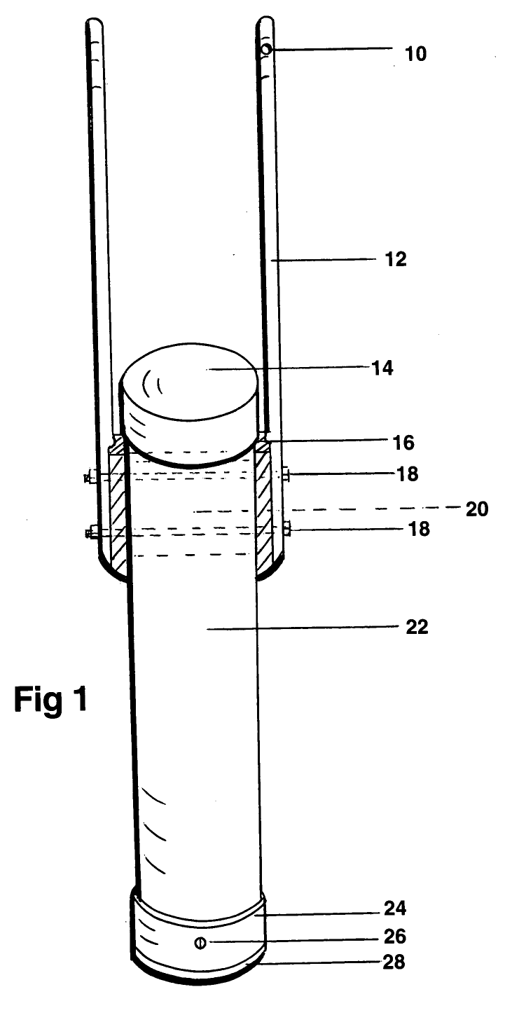

### REFERENCE NUMERALS IN THE DRAWING

10 Hole

12 Handle (one of two)

14 Top cover

16 Spacer block

18 Bolt, washer, and nut

20 Inner spacer block

22 Body

24 Bottom cover

26 Screw

28 Strike plate

### DETAILED DESCRIPTION OF THE INVENTION

A body 22 comprises an elongated container with a top cover 14 and a bottom cover 24. Attached to the base of the bottom cover is located a strike plate 28 . One or more screws 26 are located through the upward section of the bottom cover and into the lower part of the body's container. Two handles 12 are attached to the body and located directly across from each other and midway across the diameter or width of the container.

Bolts, nuts and washers 18 are located on the lower part of the handles. The bolts pass through two spacer blocks 16 and an inner spacer block 20.

### SEQUENCE LISTING

Not applicable.

1. An aluminum can crusher which comprises an elongated container with a top cover and a bottom cover and two elongated handles interconnected to two block spacers and an inner block spacer located inside the container and with bolts through them all and nuts and washers used for tightening means.

2. The aluminum can crusher of claim 1 wherein said handles, bolts, nuts, washers, and block spacers all slip into the container body to form a marketing kit.
